(19) United States
(12) Patent Application Publication
(10) Pub. No.: US 2015/0016951 A1
(43) Pub. Date: Jan. 15, 2015

(54) PLANT AND METHOD FOR DAMPING ACOUSTIC VIBRATIONS IN A CORRESPONDING PLANT

(71) Applicant: Siemens Aktiengesellschaft, Munich (DE)

(72) Inventors: Peter Berenbrink, Bochum (DE); Frank Deidewig, Essen (DE); Holger Gedanitz, Bochum (DE); Dirk Huckriede, Korschenbroich (DE); Stephan Minuth, Mulheim a.d. Ruhr (DE); Bernd Prade, Mulheim (DE); Horst Uwe Rauh, Essen (DE); Stephan Schestag, Oberhausen (DE)

(73) Assignee: SIEMENS AKTIENGESELLSCHAFT, Munich (DE)

(21) Appl. No.: 14/373,663

(22) PCT Filed: Nov. 7, 2012
(86) PCT No.: PCT/EP2012/071999

§ 371 Date: Jul. 22, 2014

(30) Foreign Application Priority Data
Feb. 2, 2012 (EP) 12153621.3

(51) Int. Cl. F01D 25/04

(52) U.S. Cl. CPC F01D 25/04; F05D 2260/963
USPC 415/1; 415/119

(57) ABSTRACT

A facility, in particular a power plant, is provided having a steam turbine and a bypass station for diverting a working medium, as required, for the steam turbine around the steam turbine, wherein at least one resonance absorber is provided for the bypass station.

### CROSS REFERENCE TO RELATED APPLICATIONS

This application is the US National Stage of International Application No. PCT/EP2012/071999 filed Nov. 7, 2012, and claims the benefit thereof. The International Application claims the benefit of European Application No. EP12153621 filed Feb. 2, 2012. All of the applications are incorporated by reference herein in their entirety.

### FIELD OF INVENTION

The invention relates to a plant, in particular a power plant, comprising a steam turbine and a bypass station for, if necessary, diverting a working medium for the steam turbine around the steam turbine. The invention further relates to a method for damping acoustic vibrations in a corresponding plant.

### BACKGROUND OF INVENTION

In power plants, there is a frequent need to take measures for reducing the sound emission of the power plant in order not to exceed the permitted limit values for sound emission.

If for example steam turbines are used in a corresponding power plant, a bypass station for, if necessary, diverting a working medium for the steam turbine around the steam turbine is also typically provided. Such a bypass station generally comprises a pipeline with the aid of which the working medium is conducted directly into a condenser rather than through the steam turbine. In this case, the pressurized working medium generates frequently low-frequency sound at a frequency of between 125 Hz and 8 kHz in the pipeline, this sound being transmitted via the pipeline into the condenser. The condenser acts here like a loudspeaker which emits the sound into the environment. As a result, this can not only become a nuisance to adjoining residential areas but in the worst case can exceed the permitted limit values, thereby contravening the operating permit of the power plant.

In order to reduce the sound emission, it is currently conventional to place throttle systems of complex structure, for example composed of various perforated plates, within the pipeline.

### SUMMARY OF INVENTION

Against this background, the invention is based on an object of specifying a simpler solution for reducing the sound emission of power plants.

This object is achieved according to the invention by a plant having the features of the claim(s). The dependent claims contain partly advantageous and partly independently inventive developments of this invention. Furthermore, the object is achieved according to the invention by a method having the features of the claim(s).

The plant is in particular a power plant for generating electrical energy or a subassembly of a corresponding power plant. The plant comprises in this case a steam turbine and a bypass station for, if necessary, diverting a working medium for the steam turbine around the steam turbine, wherein at least one resonance absorber is provided for the bypass station. Resonance absorbers, as are known in principle to a person skilled in the art, are used primarily when sound emission at individual discrete frequencies or in a few narrow frequency bands is to be expected. Since, in a plant having a bypass station of the type mentioned at the beginning, a frequency spectrum of the sound emission is typically present, said frequency spectrum being dominated by individual frequencies or a few narrow frequency bands in the range of less than 500 Hz, but to some extent also higher, resonance absorbers are suitable for damping the sound emission in a frequency-selective manner in such plants with relatively simple technical means so that the properties of the sound emission modified by means of the resonance absorbers are altered to such an extent that not only does it fall below the prescribed limit values but noise nuisance to adjoining residential areas is avoided.

The resonance absorber is embodied as a Helmholtz resonator. Corresponding Helmholtz resonators are well known to a person skilled in the art and are used in a wide variety of technical fields for manipulating the sound emission of devices or the acoustics in enclosed spaces. Accordingly, extensive data and experience are available, on the basis of which it is possible to adapt such a Helmholtz resonator to the properties of the plant with reduced technical outlay.

An embodiment of the plant in which the bypass station comprises a pipeline and in which the resonance absorber is formed substantially by a chamber at least partially encircling the pipeline, said chamber being connected in a sound-conducting manner to the pipeline preferably via a plurality of through-openings that are distributed preferably in a regular manner around the circumference of the pipeline, is furthermore expedient. The structure of the subassembly made up of the pipeline and resonance absorber is thus substantially cylindrically symmetrical, wherein the manufacturing outlay for a corresponding subassembly is kept low.

As an alternative thereto, provision is made of a variant of the plant in which the bypass station comprises a pipeline, and in which the resonance absorber is formed substantially by a chamber positioned next to the pipeline, said chamber being connected in a sound-conducting manner to the pipeline via a resonator neck. This variant, too, can be realized with relatively low technical outlay.

In addition, an embodiment of the plant in which the Helmholtz resonator is embodied as a controllable Helmholtz resonator, wherein the resonance frequency of the Helmholtz resonator is settable, is advantageous. The resonance frequency is set in this case preferably by varying the volume of a resonance body of the Helmholtz resonator, in that for example a piston is moved in a cylinder. In this way, the resonance absorber can be coordinated in the installed state with the plant in which said resonance absorber is installed, such that a single resonance-absorber type can be used for different plants using the principle of equal parts.

An embodiment of the plant in which a plurality of resonance absorbers are provided to damp in each case one frequency or a narrow frequency band is furthermore expedient. Moreover, depending on the embodiment variant, the resonance absorbers are additionally coupled to absorption silencers such that a specific damping behavior that is coordinated particularly well with the respective plant is provided. The absorption silencers are in this case formed typically by an absorbent material such as mineral wool or stainless steel wool which is introduced into at least one resonance body of at least one resonance absorber.

A variant of the plant in which the resonance absorber is positioned between a cooling medium injection and a condenser is furthermore expedient since from experience sound generation takes place precisely in this region. Generally, the resonance absorber is arranged preferably at the location of the highest sound pressure.

A variant of the plant in which the resonance absorber has a resonance body and wherein a temperature-control plant is provided for the resonance body, said temperature-control plant being used to set a substantially uniform temperature for the entire resonance body, is moreover advantageous. As a result of the temperature control of the resonance body, uniform boundary conditions and consequently also a natural frequency spectrum provided by the geometry of the resonance body are specified for the latter. It is precisely in this frequency spectrum that the damping of the sound emission by the resonance absorber then takes place.

In an advantageous development, the resonance body is flowed through by the working medium via an additional feed line in order to set the uniform temperature. In this case, the working medium that is used to set the uniform temperature for the resonance body is extracted preferably at a position in the line system for the working medium upstream of the cooling medium injection. The extraction takes place here in particular with the aid of a simple branch line such that the outlay for realizing the temperature-control plant is at a very low level.

It is furthermore advantageous when the resonance body has drainage openings for discharging condensate. This variant is advantageous especially when steam is used as the working medium, since in this case it can be expected that condensate would otherwise collect in the resonance bodies with the result that the damping properties of the resonance absorber would gradually deteriorate.

### BRIEF DESCRIPTION OF THE DRAWINGS

Exemplary embodiments of the invention are explained in more detail in the following text with reference to a schematic drawing, in which:

FIG. 1 shows a block diagram illustration of a bypass station having a resonance absorber,

FIG. 2 shows a sectional illustration of the structure of the resonance absorber, and

FIG. 3 shows a sectional illustration of an alternative bypass station having an alternative resonance absorber.

### DETAILED DESCRIPTION OF INVENTION

Mutually corresponding parts are provided in each case with the same reference signs in all the figures.

In the exemplary embodiment described in the following text, the plant 2 is part of a power plant for generating electrical power and to this end comprises a steam generator 4, a condenser 6, a steam turbine 8, a bypass station 10 and a line system 12 constructed substantially from pipelines, said line system 12 connecting the individual abovementioned subassemblies together and being used to conduct a working medium, in this case water and steam.

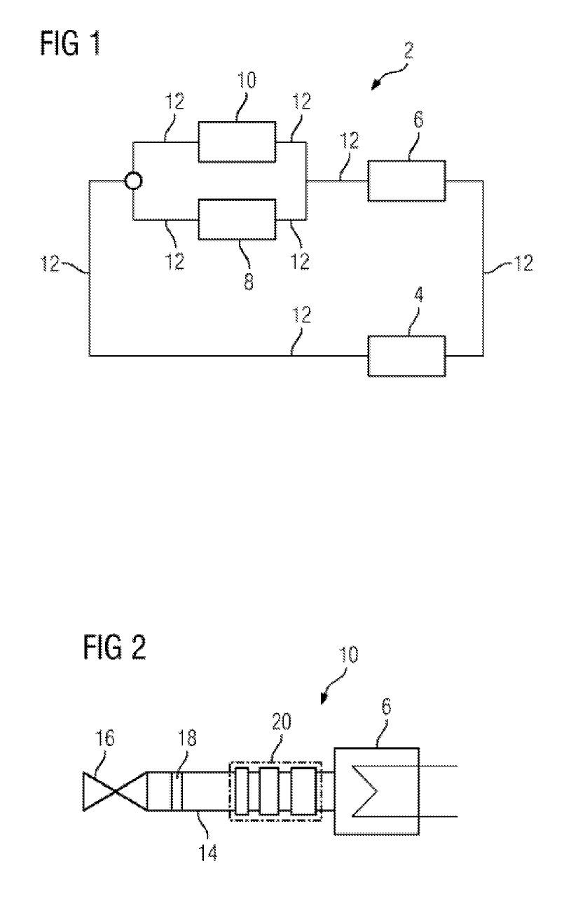

As illustrated in FIG. 1, two possible routes through the line system 12 are provided for the water or steam, wherein during load operation the steam is conducted through the steam turbine 8 and wherein during non-load operation the steam is conducted through the bypass station 10.

A very expedient configuration variant of the bypass station 10 is illustrated in FIG. 2 in the manner of a block diagram. The bypass station 10 is constructed from a conduit 14 which is connected to the line system 12 via a controllable bypass valve 16. By corresponding actuation of the bypass valve 16, a switch can be made between the two operating modes of the plant 2 that are relevant here, i.e. load operation and non-load operation, such that, if necessary, rather than being conducted through the steam turbine 8, the steam generated in the steam generator 4 is conducted through the bypass station 10 and thus through the conduit 14. Connected downstream of the bypass valve 16 is a water injection 18 which, if necessary, is used to cool the steam flowing through the conduit 14. After flowing through the bypass station 10 or the steam turbine 8, the steam is introduced into the condenser 6 and made to condense there. Finally, the water returned to the condenser 6 is subsequently fed back to the steam generator 4 by means of a water pump.

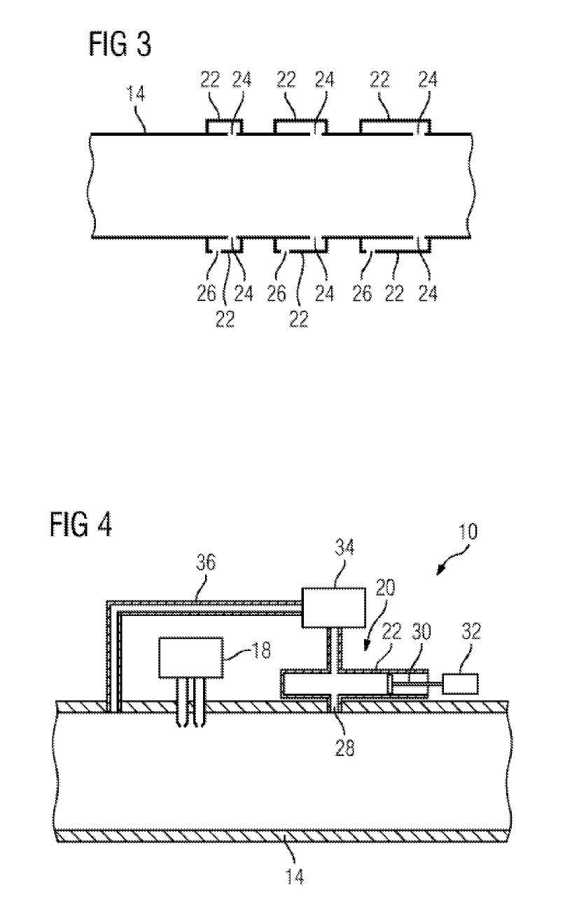

In order to reduce the sound emission of the plant 2, a resonance absorber 20 is integrated into the bypass station 10, said resonance absorber 20, as indicated in FIG. 3, being constructed for example from three Helmholtz resonators 22 that are arranged in a row along the conduit 14. Each Helmholtz resonator 22 is formed by a hollow cylindrical resonance body or an at least partially encircling resonance chamber which is connected in a sound-conducting manner to the conduit 14 via a plurality of slots 24 that are distributed around the circumference of the conduit 14. In addition, for each resonator chamber of the corresponding Helmholtz resonator 22, provision is made of at least one drainage opening 26 via which a condensate that arises in the resonance chamber can flow away with the assistance of gravitational force.

An alternative configuration of the resonance absorber 20 is shown in FIG. 4. In this case, a single Helmholtz resonator 22 having a single cylindrical resonance chamber is provided, said Helmholtz resonator being positioned, as seen in the direction of flow of the steam, between the water injection 18 and the condenser 6 and being arranged next to the conduit 14. In this exemplary embodiment, the Helmholtz resonator 22 is connected in a sound-conducting manner to the conduit 14 via a single opening that acts as a resonator neck 28. Furthermore, the Helmholtz resonator 22, as indicated in FIG. 4, is embodied as a controllable Helmholtz resonator 22, in the case of which the resonance frequency or rather the resonance frequency spectrum is settable. To this end, the volume of the resonance chamber is varied by changing the position of a plunger 30 with the aid of an actuated electric motor 32. In this way, the resonance absorber 20 can be precisely coordinated with the structural properties of the plant 2 and also with the current operating conditions.

In addition, if necessary, steam is introduced, optionally with the aid of an actuable pump 34, into the resonance chamber of the Helmholtz resonator 22, wherein the corresponding steam is extracted from the conduit 14 via a branch line 36 at a position upstream of the water injection 18. As a result, the walls of the Helmholtz resonator 22 are temperature-controlled with relatively little technical outlay such that a uniform temperature is provided for the entire Helmholtz resonator 22 and the penetration of steam/water mixture or steam with a possibly varying temperature into the resonator is prevented.

The invention is not limited to the above-described exemplary embodiment. Rather, other variants of the invention can also be derived therefrom by a person skilled in the art without departing from the subject matter of the invention. In particular, all of the individual features described in conjunction with the exemplary embodiment are furthermore also combinable with one another in other ways without departing from the subject matter of the invention.

1. A plant, comprising
a steam turbine and a bypass station for, if necessary, diverting a working medium for the steam turbine around the steam turbine,
wherein at least one resonance absorber is provided for the bypass station, and
wherein
the resonance absorber is embodied as a Helmholtz resonator.

2. The plant as claimed in claim 1,
wherein
the bypass station comprises a pipeline, and
wherein the resonance absorber is formed substantially by a chamber at least partially encircling the pipeline, said chamber being connected in a sound-conducting manner to the pipeline via a plurality of through-openings that are distributed around the circumference of the pipeline.

3. The plant as claimed in claim 1,
wherein
the bypass station comprises a pipeline, and
wherein the resonance absorber is formed substantially by a chamber positioned next to the pipeline, said chamber being connected in a sound-conducting manner to the pipeline via a resonator neck.

4. The plant as claimed in claim 1,
wherein
the Helmholtz resonator is embodied as a controllable Helmholtz resonator, in the case of which the resonance frequency is settable.

5. The plant as claimed in claim 1,
wherein
a plurality of resonance absorbers are provided to damp in each case a narrow frequency band.

6. The plant as claimed in claim 1,
wherein
the resonance absorber is positioned between a cooling medium injection and a condenser.

7. The plant s claimed in claim 1,
wherein
the resonance absorber has a resonance body, and
wherein a temperature-control plant is provided for the resonance body, said temperature-control plant being used to set a substantially uniform temperature for the entire resonance body.

8. The plant as claimed in claim 7,
wherein
the resonance body is flowed through by the working medium via an additional feed line in order to set a uniform temperature.

9. The plant as claimed in claim 7,
wherein
the working medium that is used to set the uniform temperature for the resonance body is extracted at a position in the line system for the working medium upstream of the cooling medium injection.

10. The plant as claimed in claim 7,
wherein
the resonance body has drainage openings for discharging condensate.

11. A method for damping acoustic vibrations in plants having a steam turbine and having a bypass station for, if necessary, diverting a working medium for the steam turbine around the steam turbine,
the method comprising:
using at least one resonance absorber that is integrated into the bypass station for damping.

12. The plant as claimed in claim 1, wherein the plant comprises a power plant.
